(19) United States
(12) Patent Application Publication
(10) Pub. No.: US 2003/0225619 A1
(43) Pub. Date: Dec. 4, 2003

(54) System and method for dealing with loyalty program points

(76) Inventors: Maynard Dokken, Vancouver (CA); Mikiko Fujisawa, Vancouver (CA)

Correspondence Address: Paul Smith Intellectual Property Law, 330-1508 West Broadway, Vancouver, BC, V6JIW8, CA

(21) Appl. No.: 10/388,233

(22) Filed: Mar. 14, 2003

Related U.S. Application Data
(60) Provisional application No. 60/364,084, filed on Mar. 15, 2002.

(51) Int. Cl. G06F 17/60

(52) U.S. Cl. 705/14

(57) ABSTRACT

A system for exchanging and valuing points or rewards from a plurality of loyalty programs using a “settlement point” in a clearinghouse to settle, convert, credit and debit points between accounts regardless of the type of goods or services. The points are underwritten using assets and guarantees held by a custodian, relying on actuarial estimates of redemption. The points are also used as assets for securities, thereby facilitating the valuing and liquidity of the settlement points, or as assets to secure financial or insurance services.

### CROSS-REFERENCE TO RELATED APPLICATIONS

The applicants hereby claim domestic priority benefits from U.S. Provisional Patent Application No. 60/364,084, entitled System and Method for Dealing with Loyalty Program Points, filed Mar. 15, 2002.

### FIELD OF THE INVENTION

The invention relates to loyalty programs. In particular the invention relates to the conversion or exchange of points between different loyalty programs and the purchase and redemption of points. The invention also relates to the securitization of points representing loyalty program points and to the use of such points to underwrite securities, and to act as underlying assets for financial service companies and insurers.

### BACKGROUND OF THE INVENTION

In the marketplace, there are various loyalty programs that reward loyal customers. The loyalty programs allow customers to acquire points as they purchase products. These points can be applied to payments for future purchases, discount or cash rebates. The rewards or points can also be redeemed for specific goods or services.

The principle of a loyalty program is to maintain an existing customer base as it is more expensive to bring in new customers than to maintain existing ones. The programs also motivate the customer to buy and they make use of the programs' remaining resources to acquire new customers.

Consumers carry many incentive-based credit cards or loyalty membership cards in their wallets, and collect points without knowing the exact values and advantages of rewards of the loyalty programs. There exist Internet-based services that provide conversion rates to facilitate the exchange of points or air mileages between various specific loyalty programs, but they are limited to exchanging points between only two loyalty programs at a time and hence between only the goods and services associated with those two specific programs. It is also frequently the case that consumers earn large volumes of travel or other points through various programs but the points become irredeemable by the passage of time, the discontinuance of loyalty programs, new restrictions or insolvency. This has been partly recognized in the marketplace, in that some insurance companies will insure rewards under certain terms and conditions.

The value of the rewards and points for many programs are therefore in question, yet the awarding and redeeming participants will sometimes be partly dependent on these loyalty programs to maintain their cash flow.

There is also a cost to maintaining loyalty programs and the issuers do not properly leverage the rewards or points for the awarding and redeeming participants or realize the full value of the points as assets of the program, despite their redemption and exchange value.

Various limited and individual aspects of the invention broadly evoke certain features of pre-existing systems and the following discussion of some of those provides a useful background to appreciate the novelty of the present invention.

Cash rebates credit cards allow customers to receive a percentage of their total purchased amounts in cash, or in some case in the form of investments in mutual funds or college savings. According to Asset-Backed Special Report by Fitch IBCA, Duff & Phelps dated Apr. 4, 2001, one of the asset-backed securities (ABS) market's most stable and widely accepted asset classes is securities backed by credit card receivables. They claim it has provided investors with a relatively liquid secondary market. These fundamentals, along with ongoing structural evolution of master trusts and the emergence of Employee Retirement Income Security Act (ERISA) eligible issuance trusts have driven demand for card-backed securities.

The collateral supporting credit card ABS consists of receivables generated through customer purchases and, in some cases, cash advances. Credit card ABS typically falls into one of two categories: general purpose credit card ABS or retail credit card ABS. As with the securitization of other assets, the goal in credit card ABS is to transfer the receivables generated from the credit card accounts established by the seller into a bankruptcy remote trust that functions as the issuer of the credit card ABS. The seller remains the owner of the credit card account but initially transfers the outstanding receivables, if any, to the trust and pledges to transfer any future receivables generated by the account, which the trust typically purchases at par. This is much like a credit line issued to a business.

Master trusts allow issuers to sell multiple securities from the same trust, all backed by the same collateral pool of receivables. The structure enables issuance of independently issued senior and subordinate notes with unmatched maturities. By employing the latter “multiple issuance series” technology, the issuer can issue short term certificates which mature at the end of the month and also more effectively manage financing opportunities by strategically tapping pockets of investor demand across rating categories. An ERISA-eligible legal structure would complement this flexibility by broadening the potential base of buyers' flexibility by broadening the potential base of buyers to include the largely unused pension fund universe.

The typical transaction structure has three different cash flow periods: revolving, controlled accumulation or amortization, and early amortization. Each period performs a distinct function and allocates cash flows differently. This structure is designed to mimic a traditional corporate bond, in which interest payments are made every month and principal is paid in a single “bullet” payment on the maturity date. All collections on the receivables are split into finance or transaction charge income and principal payments. Each of the three periods treats finance charge or transaction income in the same manner. Monthly finance or transaction charges are used to pay the investor coupon and serving fees, as well as to cover any receivables that have been charged off in the month. Any income remaining after paying these expenses is usually called excess spread and is released to the seller. However, principal collections are allocated differently during each of the periods.

As would be the case with most business credit lines, this type of credit is considered an unsecured debt obligation as credit card receivables offer no collateral in the event of cardholder default. As a result, recoveries are limited to the strength of the issuer's servicing operation. To achieve investment-grade ratings, credit enhancement is needed to insulate investors from fluctuating payment patterns and chargeoffs, as well other disruptions of cash flow to the trust. Common forms of credit enhancement after excess spread has been depleted are subordination, overcollateralization, and/or cash collateral accounts (CCAs).

Mutual funds are created under very specific guidelines that build integrity into the system. In exchange traded funds they are created in a process that includes a composition file, which outlines the securities or profile of securities which it is designated to purchase. This file gets routed through intermediaries that direct the list of securities to the correct destination, the trustee. Reduced to its most simplistic form the creation merely involves depositing a massive portfolio of securities into the hands of a trustee. The entities in the process include a fund advisor/manager such as Bank of New York responsible for portfolio management and ensuring that it replicates the composition file as much as possible. It also publishes the portfolio composition file to the marketplace. This is a critical file that tells “creators” exactly what stock and how many shares of each component will have to be delivered to the custodian.

A distributor manages all creation orders that are processed and approved by the distributor before any portfolio deposits are made to the custodian. Any creation order instructions can be rejected if they are not submitted in proper form. The creation or redemption instructions are delivered to the trustee. The authorized participant is usually a broker-dealer, professional trading house, institutional firm, or specialist. An agent or custodian is the manager and the custodian responsible for the trade settlement and underlying basket of stock. It facilitates the creation unit-redemption unit processes through the clearing process by sending the creation and redemption instruction file (from the distributor) to NSCC. The National Securities Clearing Corporation (NSCC) has been renamed the DTCC after its merger with the Depository Trust.

If the specialist wants to create more mutual funds, somehow the issues or names that make up the composite need to get to the trustee in a reliable fashion. The NSCC clears and settles all the trades for the portfolio baskets, as well as the exchange-traded funds. The NSCC also receives the composite file from the trustee and disseminates the list of component stocks on this file. It accepts the creation and redemption instructions from the trustee in a process called bursting, it transacts the trades for each of the stocks in the index in the exact share amount according to the composite file and the number of creation units desired. The clearing and settlement are accomplished through the continuous net settlement system of the NSCC, which provides all the trade details to parties, the authorized participant and the trustee. This system builds integrity and accountability into the creation and redemption process.

Data from commodities can be used to sell projected risk or opportunities ahead of the market such as with futures and options markets as in the Chicago Board of Options Exchange for chemical, commodity, currency, index and interest futures and options products.

The foregoing approach to building integrity and confidence, along with methods or tracking metric such as data received and managed by an advisor or manager, can be used by insurers and other rating agencies to qualify and quantify the integrity and quality of the settlement points system of the present invention. Awarded points through loyalty programs should have value and securitization of points through this unique method has tremendous value to all parties.

### SUMMARY OF THE INVENTION

One of several aspects of the present invention is to create “settlement points” that are exchangeable against the points from a plurality of loyalty programs. The settlement points are managed through a clearing house. The clearinghouse provides the ability to settle, convert, credit and debit points between accounts maintained by member merchants or customers.

The system of the invention brings universality to loyalty programs and points redemption wherein points can be redeemed for any type of goods or services. It builds more real and perceived value for the customers by rewarding them with a loyalty program that gives flexibility as the points used can be redeemed at any system participant.

The ability to exchange settlement points for loyalty program points provides the awarding or redeeming merchant with an opportunity to leverage the loyalty program to provide temporary or consistent positive cash flow with the sale of the rewards or points in the public market using settlement points as an underlying guarantee of redemption.

Building integrity into the creation and redemption process of settlement points provides the opportunity to underwrite the settlement points using assets and guarantees held by a custodian, using actuarial estimates of redemption to leverage the underlying assets and using the settlement points as assets for securities, insurance, financing, credit lines. It provides the opportunity to build a trust structure to hold these assets, which trust (through an issuer) grants and holds credit line receivables of participants and which trust can issue securities to finance the receivables using the settlement points and receivables related assets as underlying security.

The invention provides a method of enabling the seamless exchange, regardless of the goods or services, of loyalty points or loyalty rewards based on a centralized clearinghouse. settlement points are used to settle, convert, credit and debit points between accounts as transmitted through a network and as an asset. An agreement is established between the organization which enables their loyalty program and an authorized issuer of the settlement points. This establishes both a quantitative and a qualitative relationship between all parties, provides participants with a mechanism to leverage their loyalty programs and to sell rewards based on ratios of settlement points. It also allows the use of the settlement points as an asset to support insurance, securities, trusts and clearinghouses and using the trusts through the issuer to grant credit lines to participants.

This “settlements points” data can also be used to develop futures and options products based on the quantity, time and type of settlement points which are transacted. Theses options and futures can be formed into an index or other types of products and sold through regulated exchanges or as lawfully allowed through the settlement points clearing house affiliates.

Other features and aspects of the invention will be appreciated by reference to the detailed description that follows.

### BRIEF DESCRIPTION OF THE DRAWINGS

The preferred embodiment of the invention will be appreciated by reference to the following drawings thereof:

FIG. 1 is a diagram of clearinghouse and points bank operation according to the preferred embodiment;

FIG. 2 is a diagram of the security account, sub-account and clearinghouse structure;

FIG. 3 is a diagram of a floating points exchange transaction;

FIG. 4 is a diagram of the entities and process involved in creating settlement points.

FIG. 5 is a diagram of aspects of the securitization of the settlement points;

FIG. 6 is a diagram of the system structure; and,

FIG. 7 is a diagram illustrating some of the principal entities in the system of the preferred embodiment.

### DETAILED DESCRIPTION OF THE PREFERRED EMBODIMENT

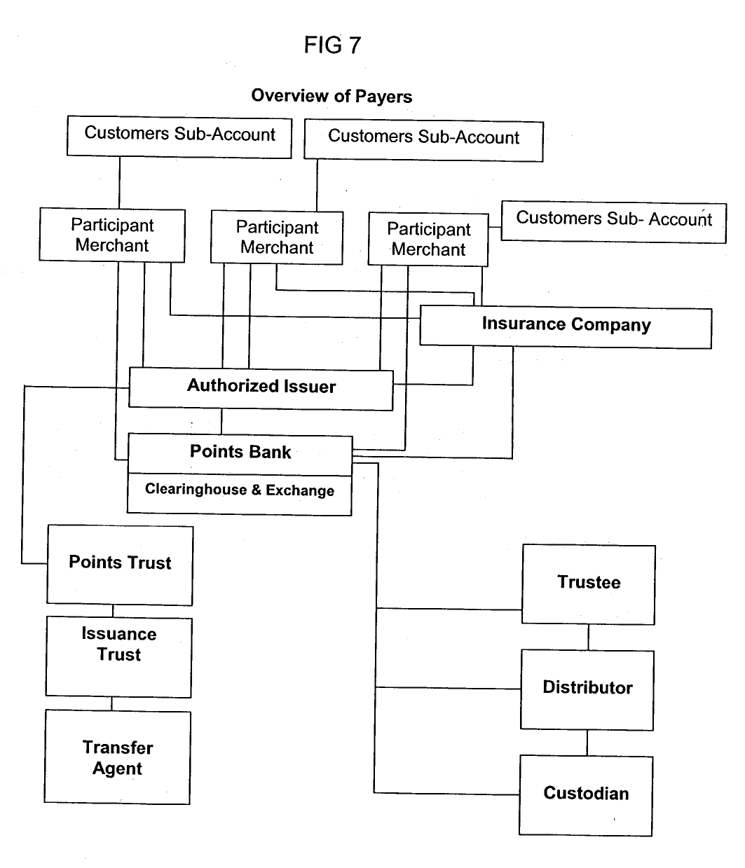

Referring first to FIG. 7, the principal entities participating in the preferred embodiment of the invention are customers, merchants, a points bank, an authorized issuer, an advisor, a custodian, a trustee, a distributor, a points trust, issuance trust, a transfer agent, an insurer, and a loyalty bureau, the functions of each of which is described in more detail below.

Customers may be individuals or businesses, who purchase or redeem points in participating loyalty programs. The invention accommodates points from a plurality of separate loyalty programs, each of which is typically managed and operated by a separate loyalty program operator. In the system of the invention, each customer is assigned a virtual settlement points account that is used to track the customer's relationship to each of the specific loyalty programs that the customer may be associated with and that are accommodated by system. This also allows the system to assess the total liability should a customer choose to simultaneously redeem all of such points.

The term “Merchants” or “Participants” contemplates participating retailers, merchants, loyalty program operators, independent manufacturers, service providers and related organizations, all of whom grant points or rewards to customers. Each Merchant/Participant obtains points from their own loyalty program operator. In this disclosure, such points are termed “house-branded” points. Merchants sometimes provide customers with house-branded cards and accounts.

The preferred embodiment of the invention contemplates a loyalty program bureau that evaluates the merchant for its suitability in the settlement points rewards or points system. Such suitability may be determined by factors such as background, credit-worthiness and whether sufficient insurance, capital and procedures are maintained. It may require an insurance policy, which covers liability for loyalty programs to ensure that the participating house-branded points will retain value in the system of the invention even if the issuer of such points encounters financial or redemption difficulties. The loyalty program bureau also handles dispute resolution between Customers and Participants. The Merchant/Participants advise the loyalty program bureau of the goods and services for which they award or redeem house-branded points and of the exchange ratios between the house-branded points and the settlement points of the invention. A default ratio may be determined by the value or price of the goods and services if convenient. Participants may be required to display the exchange ratio to settlement points based on their house-branded points in all transactions.

Participants may maintain their own loyalty cards and system. In such case, Participants could be identified by an account translation system based on their location or organization using a specific ID and translate their customer's in-house account numbers to an account number specific to the system of the invention.

An “Awarding Participant” is a Participant that grants points when a Customer purchases goods or services. A “Redeeming Participant” redeems points when a Customer purchases their goods or services.

In order to participate in the settlement points system of the invention, the merchant applies to one of several entities that are authorized to enroll participants in the system of the invention. Such entities are referred to herein as “Authorized Issuers” or “AI”.

The AI buys and sells settlement points (from the Points Bank) and establishes a credit relationship with Merchants/Participants to fund the acquisition of settlement points by the Merchant/Participant. Upon a merchant providing a reward to a customer (in exchange for specific loyalty program points), the merchant deals with the AI to effect redemption of the loyalty program points supplied to the merchant by the customers. The redemption may be for cash, securities or settlement points. Other functions of the AI are discussed below.

The AI also manages one or more Points Trusts, the issuance of settlement points to merchants, the redemption process of house-branded points, the opening/closing of Security Accounts, accounts receivables and the sale and block purchase of settlement points. AI keeps a record of the conversion ratios of houses-branded points issued by Participants. AI buys and sells blocks of settlement points through the Points Trust. AI sells various amounts to Participants for their Clearinghouse “Security Accounts” and to support credit lines, guarantees, and securities issuances. AI can simultaneously serve as originator of loans, servicer, administrator of the trust, underwriter, provider of liquidity, and credit enhancer. AI approves credit lines and issues instructions to Trustee to transfers by book entry settlement points purchased by account holder as underlying support. Authorized Issuers can receive a fee for each element of the transaction.

A “Points Bank” holds customer accounts (recording house-branded or program-specific loyalty points) and Merchant/Participant accounts and holds the Clearinghouse described below. The Points Bank virtually holds an accrued total of all potential liabilities of all house-branded points issued to Customers in settlement points equivalent individually and in total.

A Clearinghouse enables the universal and seamless exchange, regardless of goods or services, of loyalty program points and rewards by using a conversion ratio to settlement points. The ratio of settlement points can be based on the value of exchanged goods and services of the house-branded quantity of points. The ratios are set by the Participants and by agreement of the Authorized Issuer and the Points Bank, and may require customized terms and conditions for independent Points Trusts. The Clearinghouse holds and operates the trading, exchange and accounts of settlement points and “house-branded points”. Settlement Points can underwrite or guarantee “house-branded points”. The Clearinghouse is responsible for all additions and deletions of accounts register including monitoring of required Security Account levels and stress factors data. The Clearinghouse calculates and distributes this and other data to an Advisor/Manager.

The settlement points can also be issued in many different currencies. The settlement points Clearinghouse can be a separate entity in many different countries and jurisdictions. The settlement points Clearinghouse would exchange different settlement points in different currency jurisdictions based on the “global settlement point” of a Global Clearinghouse.

The Points Bank is the underwriter of the settlement points. It secures the issuance with: assets; guarantees, pledges, insurance; securities; cash; or cash equivalents. It can authorize the issuance of points based on the percentage of and type of assets as required by policy. A Board or Governors or authorized representatives establishes the policy and other guidelines.

A Points Trust holds settlement points in inventory purchased from the Points Bank in the settlement points creation process, as well as related assets and receivables under a trust agreement, usually with an AI. When an account holder purchases settlement points and AI approves a credit line, AI sends the receivable to the Points Trust. An independent Points Trust is a corporate entity created as a special purpose body with restrictive terms, conditions and other limitations. In an independent Points Trust the total number of settlement points deposited to support the issuance of house-branded points may be finite and thereby limit the total value of all these “legacy” house-branded points trade-ability in the Clearinghouse settlement points system.

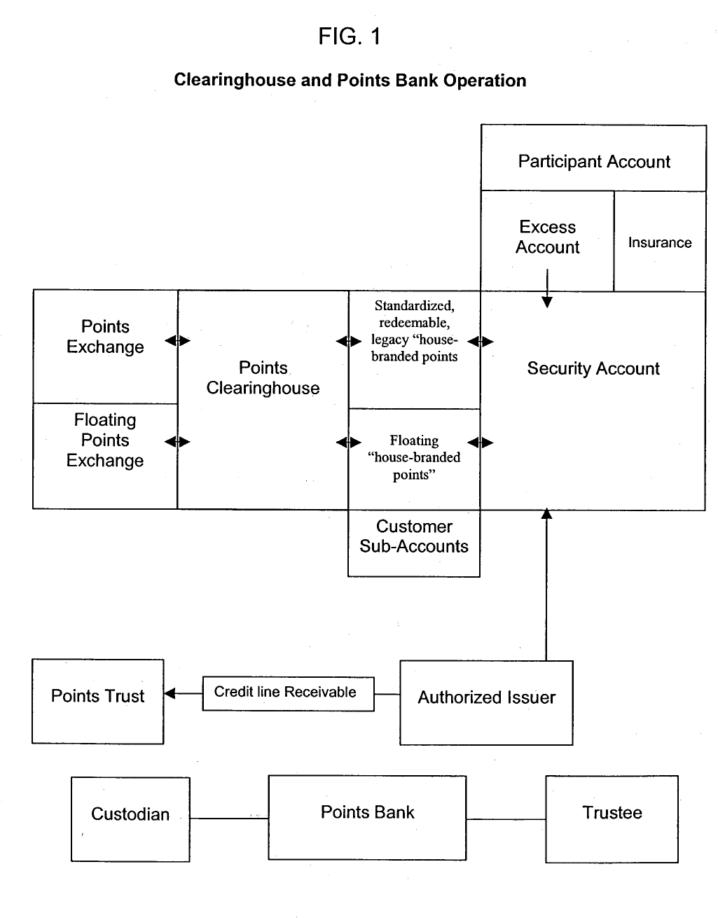

The Trustee is the creator of settlement points on behalf of the Points Bank. The Trustee is the nominated manager (also known as the agent) responsible for the trade settlement for the settlement points transactions through the Clearinghouse. It facilitates the creation unit-redemption unit process through the Clearinghouse by sending the creation and redemption instruction file (from the distributor) through the Clearinghouse systems and network. The Trustee creates, holds and transfers all settlement points by and in book entry form and on behalf of Points Bank (FIG. 1). A Trustee is the nominated manager and holds a copy of all transactions and records.

The Advisor/Manager is responsible for information management and ensuring that it disseminates the Clearinghouse information to authorized and registered participants. It publishes Clearinghouse data and disclosure including stress factors to the marketplace. This file tells “creators” exactly what accounts and how many settlement points are active including Participants accounts and related stress calculations of the Clearinghouse and Points Bank for the Points Trust Manager “AI” and securities holders. This information is also delivered to the Trustee, Custodian and rating agencies.

All creation orders are processed and approved by the Distributor before any settlement points are created or collateral deposits are made to the Custodian by the Points Bank. The distributor can reject any creation order instructions if they are not submitted in proper form with accompanying guarantees, assets or pledges of the Points Bank. The Distributor sends approved creation or redemption instructions to the Trustee.

The Custodian maintains and holds the underlying assets that support settlement points that are beneficially held by the Custodian on behalf of the Points Bank for settlement points issuances (FIG. 1).

The functions of the Transfer Agent include book entries, record keeping, and distribution services for securities.

An enabled Insurance Company may use settlement points or settlement points securities as underlying assets for issuance of loyalty based program coverage to protect against potential liabilities. Enabled Insurance could allow “Awarding and/or Redeeming Participants” to leverage their credit lines with limited resources. Based on the rating of the “Awarding and/or Redeeming Participants” the Authorized Issuer may or may not require coverage to secure against default or other liabilities.

FIG. 1 illustrates the Points Bank. Participants have two accounts at the Points Bank: a “Security Account” and an “Excess Account”. A “Security Account” holds settlement points as security against the exchange of Participant's “house-branded points”. Participants may open a credit line with the Authorized Issuer to cover their required ratio of settlement points to issued house-branded points in their Security Account. The Authorized Issuer may open a credit line without enabled Insurance if the Participants have the appropriate covenant and or credit profile.

If a Participant becomes delinquent and conventional collection efforts fail, the Authorized Issuer may request coverage from the Insurance, or draw upon all of their assets in the settlement points system to satisfy the Participant's obligations. Delinquency include exceeding the number of issuable points allowed based on their “Security Account” holdings, credit line, insurance or guarantees. If a default is not remedied in a given time frame, discontinuance of participation in the settlement points could result.

The Excess Account holds free unencumbered settlement points. These settlement points are surplus based on the number required to support their house-branded and floating points issued. The surplus can be calculated including credit lines and insurance coverage. Investment of excess settlement points into the Points Trust through an Authorized Issuer can provide Participants a method of receiving a percentage return on excess settlement points.

The “Sub-Account” belongs to a Customer and holds house-branded points, which were awarded to or purchased by the Customers. They also have a Points Bank virtual settlement points account which has the converted settlement points equivalent of all sub-account totals, from all Participants.

Customized rules for specific Authorized Issuers may require Customers from specific independent Points Trusts to deposit a portion in cash in their Customer sub-account based on the value of legacy house-branded points to be enabled.

Types of house-branded points applications can include: real estate by using the settlement points equivalent on closing of property or mortgages to secure future mortgage payments or as a security enhancement; for credit towards retirement plans or employee saving plans; medical or pharmaceutical related organizations could provide their Customer house-brand points for interchange between medical insurance companies, hospitals and clinics for goods or services including out of the community or country care; retail and the services industry; any goods or services that are sold or bartered in the marketplace.

Use of the term “house-branded” points contemplates points awarded by Participants based on a formula of the value of goods and services. There is contemplated one or more types of house-branded points, and four such types are defined as follows: Standardized, Redeemable, Floating and Legacy.

Standardized house-branded points relate to a Participant who has a successful loyalty program and has issued points to their customers under their policies, rules and regulations but wishes to have the option to enable these house-branded points. This can be accomplished by opening a Security Account at the Clearinghouse with a ratio of settlement points necessary to secure the exchange of all historical points at the Clearinghouse.

Redeemable house-branded points relate to a Participant who wishes to award their Customers with points or rewards which are unrestricted and freely tradable through the Clearinghouse.

Floating house-branded points are bid, offer, sold and transferred through the Floating “Points Exchange” by Participants and are unrestricted and freely trade-able through the Clearinghouse. The Floating “Security Account” is opened for every account holder using the Floating “Points Exchange” and for which a segregated number of settlement points are transferred and held based on a segregated ratio.

Legacy house-branded points are issued based on a specific independent Points Trust and have specific terms and conditions of redemption and may also have limitations as to the total value based on the number of settlement points allocated or deposited into the independent Points Trust.

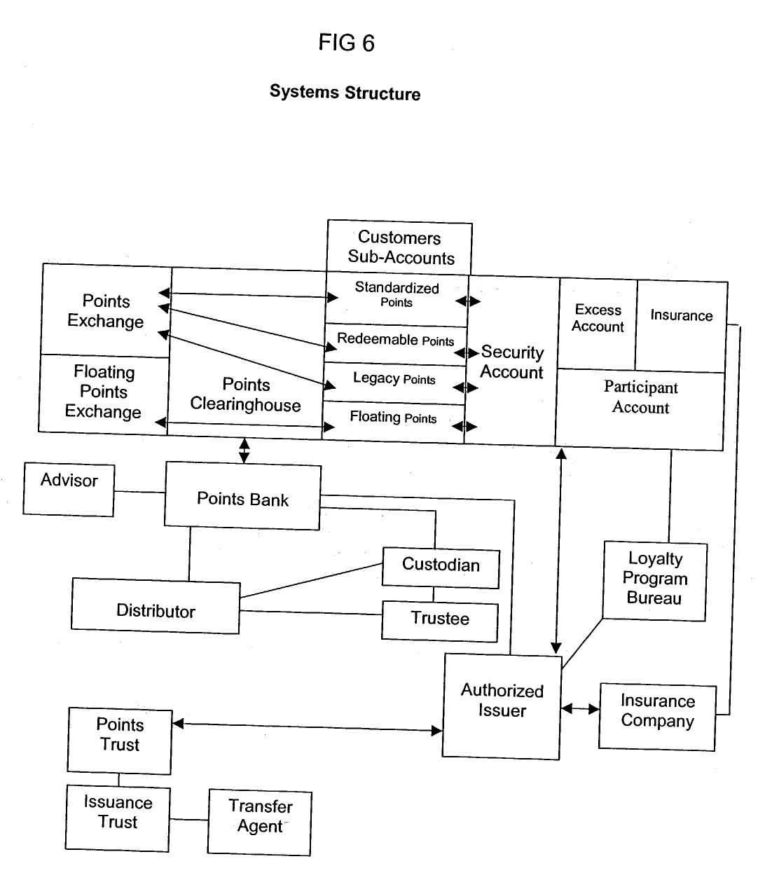

Referring to FIG. 6, the Points Bank is comprised of the clearinghouse, participants and customers accounts and exchanges. The diagram also illustrates the flow of an application from the participant, loyalty bureau, to authorized issuer. It also shows the forwarding to the insurance company if coverage is required and on to the points bank and trustee to record the transaction or opening of the account. The diagram also illustrates the basic functions of settlement points creation including advice from the points bank to the distributor and the approval therefrom to create, and transfer of assets to custodian and recording of transaction on behalf of the points bank by the trustee. It also shows the flow of receivables from the authorized issuer to the points trust and the issuance trust structure for securities issuance and recording by the transfer agent. It also outlines the advisor dissemination to all parties of clearinghouse statistics.

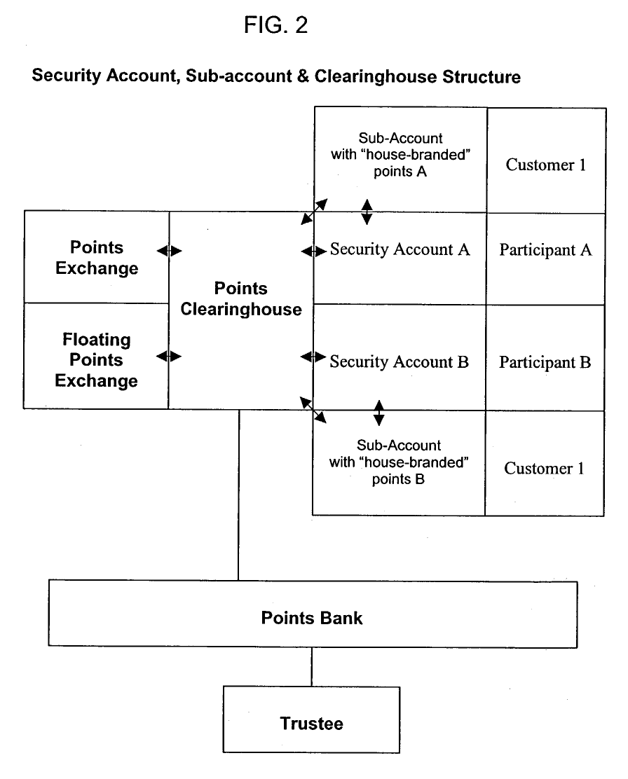

In FIGS. 1 and 2, there are two types of exchanges at the Clearinghouse: the “Points Exchange” and Floating “Points Exchange”. “Points Exchange” means that normal exchange activities between different valued points with settlement points within the limits of the Security Accounts and set ratios. A settlement points trading system would have floating house-branded points on a publicly available market. These points would be placed, or authorized, for sale on the system by Participants.

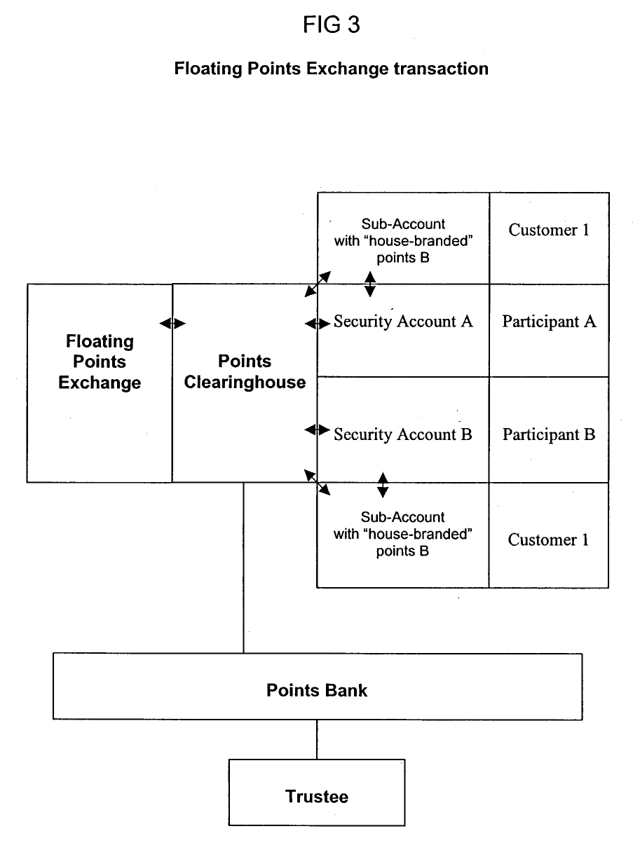

FIG. 3 illustrates a separate exchange for floating settlement points and segregated floating Security Account. Trading would be based on several criteria including: a “limit price” or minimum/maximum; “set price”; floating price; other customized settings. The number of floating house-branded points the Participant could list on the settlement points trading system would be limited by: the market for their house-branded points; the ratio of settlement points required in the floating Security Account; the number of their house-branded points they wish to place on the trading system; and other risk management policies and criteria. A Participant or Customer could bid on Floating settlement points at the Floating “Points Exchange”. Upon acceptance of the transaction, the settlement points along with accompanying balance of standardized, redeemable, legacy or floating points will be credited to the account(s) of Participant or Customer (FIG. 3).

Participants and Customers could update, manage and organize accounts using a networked computer, automated teller machine, Internet, PDA, cell phone, or other device connected to the Clearinghouse (or intelligent enabled device such as a smart card) Network directly or indirectly to update account information or request balances, or other account information individually or collectively. Participants would be able to show Customers the aggregated total of all sub-accounts throughout the Clearinghouse in their house-branded points equivalent.

Customers carrying large points balances could be provided enhanced benefits including increased discounts or credit rating enhancement. This would be based on the number of settlement points equivalent. This provides incentive(s) for enabled account holders to keep a higher balance of settlement points equivalent in their sub-accounts, retention of customers and value of settlement points in the system.

A multi tiered card system may be used to provide flexible payment methods including the requirement of a portion of the goods and services value paid in cash as well as a payment in house-branded points.

The purchase of goods and services by the Customer is a three-way process from and to the “Redeeming Participant”:

(1) The “Redeeming Participant” transmits to the Authorized Issuer an invoice for the goods or services exchanged including bundle of house-branded points received;

(2) the Authorized Issuer disapproves or approves the transaction and processes the claim

(3) If approved the Authorized Issuer requests the credit of equivalent in settlement points from the Points Bank Trustee to its account with credit to the “Redeeming Participant” of the agreed amount in securities or cash.

The debiting of points from the Customers' debit of house-branded points in exchange for goods or services at a “Redeeming Participant” involves:

(1) swiping, connecting or entering Customer's loyalty card, credit card, smart card, other connected or wireless device or identification number and transmitting a request along with necessary contact and identifying information from a “Redeeming Participant” through the Clearinghouse Network to the Authorized Issuer;

(2) consolidating and calculating Customer's earned points at various “Awarding Participants” based on their settlement points Points Bank account(s) into a redemption bundle

(3) converting into “Redeeming Participants” house-branded equivalent

(4) debiting settlement points from the various “Awarding Participants” “Security Accounts”

(5) debiting on a default or pro rata basis of the Customer's credits based on its sub-accounts equivalent in settlement points of “Awarding Participants” until any of the Customers sub-account equivalent(s) is exhausted and thereafter recalculated from the remaining accounts.

(6) approval and final settlement through the Clearinghouse and Authorized Issuer and related Networks, Business Partners and processes.

An aggregated debit could be programmed on a weighed, proportionate, or any mathematical combination or computation basis. The weighed average debit example would be based on the number outstanding and size of the average trading volume of settlement points of the company. An aging formula could be used based on the oldest points redeemable first.

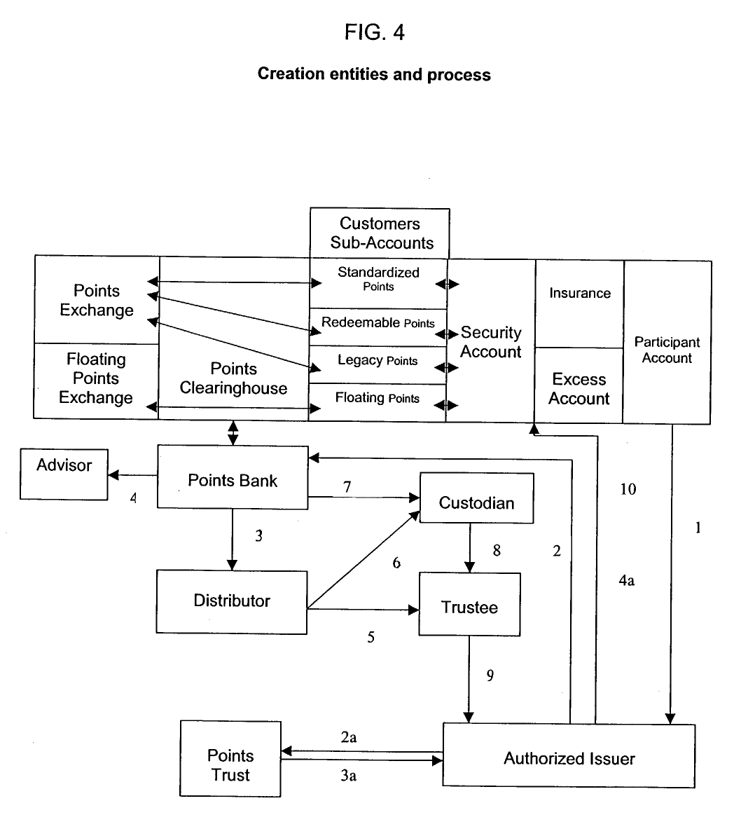

FIG. 4 illustrates the method of creation of settlement points. The settlement points are created by the Points Bank “Trustee” in block-size units. Creating settlement points, for example, requires that the creator (Points Bank “Trustee”) deposit or pledge to a Custodian the portfolio of assets or guarantees that very closely approximates the probable daily, weekly and monthly excess requirements or stress factor requirements of the Clearinghouse for that issuance. Only the Trustee can create or redeem.

If a “Redeeming Participant” has extra or unencumbered settlement points they can redeem in blocks with the Points Bank. The Points Bank can either redeem the settlement points for consideration or they can offer the settlement points to an Authorized Issuer. The Authorized Issuer can purchase through a Points Trust for which a security would be issued to the “Redeeming Participant” or a security can be sold for cash. Creators and redeemers also pay a creation and redemption fee and are responsible for accrued payments, custodial and transfer fees for the underlying settlement points.

The Trustee clears and settles all transactions through the Clearinghouse on behalf of the Points Bank. The Trustee receives the Creation Unit files from the Distributor through the Points Bank and the list of assets to be secured for issuance of the settlement points. Redemption Units are bundles of house-branded points and the accompanying conversion data from a request for redemption of a Customer at an enabled “Redeeming Participant” in exchange for their goods and services. The Clearinghouse accepts the creation and redemption instructions from the Trustee and processes the transactions.

Authorized Issuers such as specialists, large institutions, have baskets of settlement points in Points Trusts or the ability to assemble baskets of settlement points in Points Trusts. Authorized Issuer first notifies Points Bank of creation intent. Points Bank notifies Distributor with back-up paperwork including confirmation of guarantee or assets delivery to Custodian. Custodian confirms underlying assets (cash deposit to cover creation fees, custody and transfer charges) against issuance to Points Bank Trustee based on Distributor paperwork. Trustee creates and confirms issuance of settlement points and upon receipt of consideration (Points Trust and/or Points Bank) by the Custodian the Trustee transfers by book entry, after settlement, settlement points to Authorized Issuer via book entry.

FIG. 4 illustrates the method of creation of settlement points from Participant requests of redemption to the Authorized Issuer “AI” (Points Trust Manager) through to the Trustee:

1a. An “Awarding and Redeeming Participant” requests purchase of settlement points from Authorized Issuer;

2a. A notification from Authorized Issuer to Points Trust of availability of unencumbered settlement points for sale;

3a. Confirmation or rejection, if confirmation then proceed to 4a otherwise 2;

4a. Sale of settlement points to “Awarding and Redeeming Participant”.

If the Points Trust does not have sufficient unencumbered settlement points to transact, the transaction will proceed as follows.

1. An “Awarding and Redeeming Participant” requests purchase of settlement points from Authorized Issuer;

2. The Authorized Issuer requests purchase of settlement points from Points Bank along with confirmation of funds availability at Trust for purchase.;

3. Points Bank sends creation request to Distributor;

4. Clearinghouse provides Advisor with data of account operations;

5. Distributor sends confirmation of receipt and acceptance of documentation required, to Trustee, for creation of new settlement points (including pledge of assets or guarantee from Points Bank);

6. Custodian receives assignment or transfer of assets or guarantees for issuance of new settlement points;

7. Points Bank transfers assignment of guarantee for creation of new settlement points;

8. Custodian sends confirmation of issuance to Trustee;

9. Trustee transfers account to Authorized Issuers by book entry on behalf of Points Bank settlement points in return for payment to Custodian;

10. Authorized Issuer sends notice to Trustee of transfer of settlement points to “Awarding or Redeeming Participant” and receives payment.

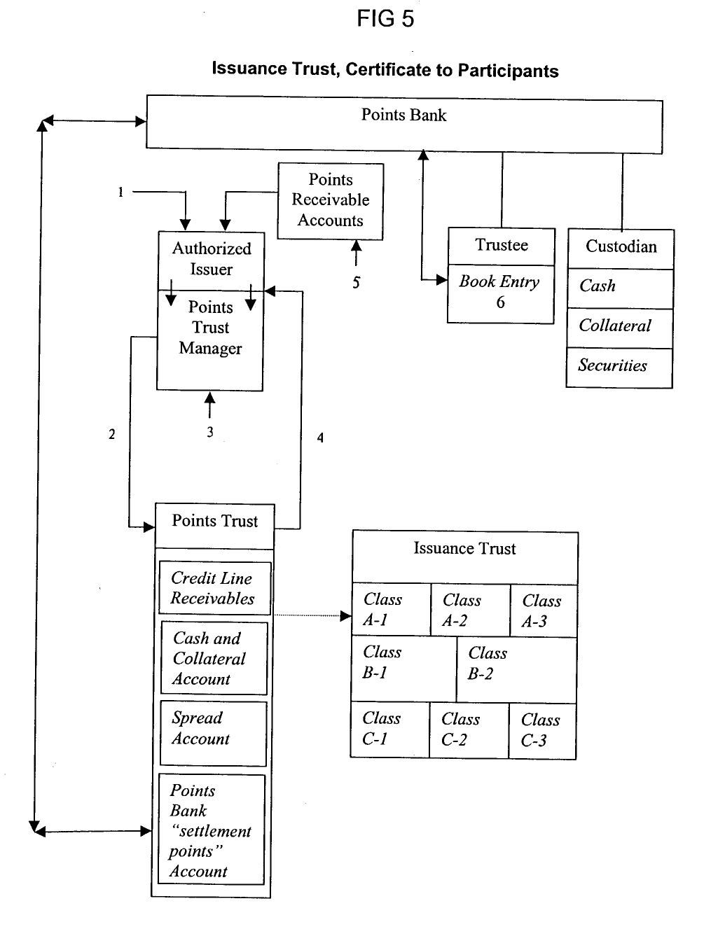

FIG. 5 illustrates Points Trust, Issuance Trust and Points Trust Manager or AI. Points receivables are sold to the Points Trust through the AI which is considered the originator. These settlement points “Security Account” receivables can be secured or unsecured debt obligations. Securities are created when there is a sale of assets or collateral to the Points Trust by the originator or Authorized Issuer. The Points Trust transfers a collateral security to the Issuance Trust which issues the securities. These securities represent an interest in the settlement points pool, insurance, receivables, cash and other underlying assets in the Points Trust. Interests in the trust, which embody the right to certain cash flows arising from the underlying assets, in the form of securities are sold to investors through an investment bank or other securities underwriter. An Issuance Trust allows for each sub series or class of security to be sold independently with different terms, maturities, and coupons. This structure enables the issuance of securities with flexible maturity dates to “Redeeming Participants” in return for their bundle of “house-branded points” and invoice(s) which they exchanged for goods and services.

1. Transactional fee and administrative profit from the buying and selling of “settlement points.

2. Assets and income to Points Trust.

3. Management, underwriting and other facilitation and administrative fees.

4. Transactional, administrative, management and related fees and income.

5. Interest, fees and other charges related to the operations of the “Security Account” credit lines.

6. Authorized Issuers Trustee account with settlement points of record.

The Points Trust may have several securities series with fixed-rate coupons and floating-rate coupons.

These securities may include one or more credit enhancements, which could raise the overall credit quality of the securities above that of the underlying assets and loans. These credit enhancements may include pools of insurance, which may be partially assigned to the Points Trust and Points Bank Trustee. The Points Trust “spread account” can be funded up to a predetermined amount through “excess yield” or interest and fee income less credit losses, servicing, and other fees. After the spread account accumulates to its predetermined level, the excess yield may revert to the Authorized Issuer. Payments collected from “Security Account” credit lines can be used to support new “Security Account” receivables generated.

The securitization conduit or the Points Trust would generally be a bankruptcy-remote vehicle such as a grantor trust. The securities may have a third party servicer or the Authorized Issuer (or other the originator of the collateral) may be responsible for collecting the cash flows generated by the assets including principal, interest, and fees net of losses and any servicing costs as well as other expenses and for passing them along to the investors in accord with the terms of the securities. The servicer processes the payments and administers the “Security Account” credit lines in the pool. The purchasing and sale of settlement points can provide transactional profit above credit line fees. The Cash Collateral Account whose funds can be derived from the buying and selling of settlement points, can accumulate up to a predetermined level and could be used to cover credit losses in the underlying asset pool, up to several multiples of historical losses on the particular assets collateralizing the securities. The Authorized Issuer may open a Cash-collateral account to provide credit protection to investors by eliminating “event risk,” or the risk that the credit rating could be downgraded if it was not be able to fulfill its financial obligation to absorb losses.

Points receivables can be sold at a discount by individual “Awarding and Redeeming Participants” to the AI thereby increasing the portfolio's yield and enhancing their credit rating. The Authorized Issuer may require a percentage deposit of settlement points in “Awarding and or Redeeming Participants” “Security Account” based on an estimated usage over a set period. The “Awarding and or Redeeming Participants” may not have funds to purchase settlement points to set off against future issuances and may acquire a credit line through the Authorized Issuer or its representatives for the “Security Account”. If the “Awarding and or Redeeming Participants” does not have sufficient covenant to qualify for a full or only partial “Security Account” credit line they may be able to receive coverage from an enabled Insurer to cover potential default, excess “Security Account” requirements, or other coverage for credit enhancement necessary for approval.

The securities can be structured to incorporate two phases in the life cycle of the collateral: an initial phase during which the principal amount of the securities remains constant, and an amortization phase during which investors are paid off.

A settlement points structure could also be used for Business Partners such as Independent Manufacturers and Service Providers. An Independent Trust with a Security Account could facilitate the issuance of the individual Independent Manufacturers and Service Providers house-branded points. They would become “Awarding Participants”. These redeemable house-branded points would be credited to the Customer for each purchase of a specific product. This new form of coupon compensates the Customer directly. The Independent Manufacturers and Service Providers model can be combined with the traditional “Awarding or Redeeming Participants” structure.

Independent Manufacturers and Service Providers could track purchasing habits of their products or services in any defined target. This information could provide a just in time delivery system for their outlets or distribution systems. It could also provide Customers just in time delivery based on their buying habits and needs.

The Independent Manufacturers and Service Providers model could provide an electronic method of distributing their product or services. The settlement points structure could provide real time accounting of product and services even at a store level. This could provide Independent Manufacturers or Service Providers a method to reduce distributor and related aged products costs.

The Clearinghouse network and system provide the operational component. The Clearinghouse is responsible for the operational construction, calculation and operations of the settlement points Clearinghouse network and system.

The data translation and transaction management system for electronic data interchange would have comprehensive standards support, and industry subsets. This data interchange system would provide an interface to modify setting to optimize communications with “Awarding and Redeeming Participants” and Business Partners.

The Clearinghouse network and system credits and debits house-branded points for each purchase instantly or hold in memory a number of updates until a threshold of customer information is ready. This method could communicate with the Clearinghouse through its Network or related clearing network.

The Clearinghouse network and system will have Point-of-Sale “POS” wireless, dial, and leased line point-of-sale and computing devices connectivity for “Awarding and Redeeming Participants”.

The Clearinghouse network will have dial up sites at each regional center for IP connectivity through a secure IP network. This option allows flexible connectivity solutions for all Participant and Business Partners. In a central dial-up host environment, the settlement points network systems can act as a host front-end-processor. The Clearinghouse network administrator will have full control over transaction routing, transaction aggregation, protocol conversion, and extensive network management.

The Clearinghouse network will be designed to send the data over a variety of networks. A multi-participants environment connecting through all POS terminals within each store or with each head office data center with traffic to the settlement points network authorizing, processing requests and payment of for goods and services.

The Clearinghouse network will be designed to remove network complexities from “Awarding and Redeeming Participants”, provide clearly defined control and monitoring interfaces as well as seamless integration to POS devices and ATMs. It will provide processing between different hosts and transfer of critical transaction data as a software and hardware solution. It will provide general-purpose protocol converters and transaction routers, connect wireless, dial ATMs and cash machines. Connect directly to transaction switches, or third party networks. Processing settlement points transactions through payment networks, and financial institutions connectivity. There are many different methods of payments including cash, checks, check on-line, “PCH/ACH” direct debit/direct payment, debit cards, credit cards and the advent of smart cards.

Smart Cards can track and download information, credits and keep this information in the memory of the card for further use. The card itself can have a microprocessor that could exchange points without connecting to the Clearinghouse. The card could also track settlement points equivalents and aggregate amounts of all enabled points in each account. It would be updated once it accessed a POS, card reader, ATM or other transaction processor that was Clearinghouse network enabled.

Rules based programming interfaces would allow customize rules design (rules based programming) for all Participants and Business Partners. This interface would provide input areas for: number of points awarded per: dollar, product; value in currency; point threshold; other data, rules and policies. The system will be integrated with host applications allowing transactions to flow rapidly between all applications. There will be a graphical interface to menus, displays, and reporting functions. Users who are accustomed to the PC graphical environment will have a graphical interface that includes all of the functions including online processing. The systems will convert application data formats to and from standard formats.

In addition, the facilities will support multiple concurrent users, locations, applications, functions, and translations for multi-tasking and regionalized or gateway implementations. For example, a large organization could interconnect the system and provide support to all their departments in multiple divisions or locations. Online customizable data standards, values, application data formats, network parameters and other partner information will be available through the Clearinghouse settlement points network system.

Online transaction, mapping will includes support for translation tables, user exits, accumulators, occurrence mapping, literals and automatic field conversions. Establish user ID control or any other security access facility interface. Security facilities includes mapping of data sources, encryption key names and authentication key names.

The systems will employ a transaction store feature that separates translation and enveloping functions to provide greater flexibility and control over the sending and receiving of transactions. Outgoing transactions, those to be sent to partners, will be translated and held in the transaction store until an “envelope” or “bundle” instruction is received. Similarly, incoming transactions will be “de-enveloped” or “de-bundled” and held in the transaction store until they are retrieved for translation. This approach will allow the system to accumulate transactions from various sources for example, different “Awarding and Redeeming Participants” locations, Business Partners and send them in batches or bundles in single envelopes for more efficient data communications.

The system will provide comprehensive tracking mechanisms of data sources and settlement via predefined and user defined reports. Users will be able to build their own queries on data of choice. Data will be viewable online or printed out in hard copy. The user will have a unique address assigned at registration, for both same-system and cross-system addressing. This address identifies the “Awarding and Redeeming Participants” and Business Partners host. This will allow another layer or security by identifying the sender, receiver and path of all data.

Participants and Business Partners using the settlement points network and systems Clearinghouse must each install a Gateway supplied and commissioned by the Clearinghouse management company. They may choose to locate the Gateway Service on their own internal network or alternatively on a subnet supplied as part of the local wireless, dial-up or broadband service access point. They may obtain and install additional gateway servers should they be required for purposes such as failure contingency, testing or trialing.

All gateways will have a port bound to a unique IP address. This feature will allow the option of having all gateways visible on the network so that the Clearinghouse network management center can monitor and maintain all gateways, even those that are not currently in live use. The Gateway Service will enroll a settlement points network certificate authority for digital certificates and digital encryption. These will be used for establishing mutually authenticated and secure communications sessions and for adding digital signatures to messages and files sent to the Clearinghouse. A Certificate authority houses the private and encryption keys which will be stored using highly secure validated hardware with multiple levels of protection such that no single individual can gain access to the private keys. The certificate authority will also maintain a certificate revocation list containing any previous certificates that have been revoked.

Products will be developed based on the settlement, house-branded or other points in the system for a futures or options index based on the industry and category within that industry or company within that industry, such as the data derived from a department store which could indicate the potential growth in sales or in a certain type of sales. This data from the points system could be packages into a data product or a futures and options product or services and allow industries to hedge their growth by purchasing forward contracts based on their industry or allow financial services companies such as investment bankers and insurance companies to purchase products to offset risks.

What is claimed is:

1. A method for facilitating the exchange and valuation of points from a plurality of loyalty programs comprising:
defining settlement points;
determining an exchange value between said settlement points and the points of each of a plurality of loyalty programs; and,
providing a clearinghouse facility to settle exchange transactions between the points of a plurality of loyalty programs, or between the points of at least one of said loyalty programs and said settlement points.

2. The method of claim 1 wherein said exchange transaction is settled by said clearinghouse by reference to the exchange value of the points of each of said plurality of loyalty programs in relation to said settlement points.

3. The method of claim 1 wherein a plurality of participants are each assigned an account for recording the number of settlement points associated with said participants.

4. The method of claim 3 wherein said account is credited or debited settlement points according the results of one of said exchange transactions.

5. The method of claim 3 wherein said plurality of participants are further assigned accounts to track their relationship with specific loyalty programs.

6. The method of claim 3 wherein an organization associated with said clearinghouse facility vets said participants for eligibility to be assigned settlement points and to participate in said exchange transactions.

7. The method of claim 3 further comprising the steps of:
designating at least one authorized issuer of said settlement points; and,
said authorized issuer issuing settlement points to a participant in exchange for consideration.

8. The method of claim 7 wherein said participant supplies security as part of the consideration for the issuance to said participant of settlement points.

9. The method of claim 8 wherein said security comprises assets and/or guarantees.

10. The method of claim 3 wherein said settlement points are used as assets backing the issue of securities.

11. A method of realizing value from loyalty program points comprising:
establishing a program for trading and exchanging points from a plurality of loyalty programs;
defining settlement points having exchange values associated with the points of said plurality of loyalty programs;
providing for the issuance and acquisition of settlement points including receiving collateral for said issuance; and,
using said collateral as the basis for issuing securities or other structured assets or contracts.

12. The method of claim 11 wherein said collateral comprises assets tendered as security for the issuance of settlement points to a participant in the exchange program.
